(19) United States
(12) Patent Application Publication
(10) Pub. No.: US 2010/0249958 A1
(43) Pub. Date: Sep. 30, 2010

(54) SYSTEM FOR SPORTS ACTIVITY

(75) Inventors: Timo Salmi, Vantaa (FI); Tomi Salmi, Vantaa (FI); Antti Jylhä, Helsinki (FI); Vesa Välimäki, Espoo (FI); Cumhur Erkut, Helsinki (FI)

Correspondence Address: BIRCH STEWART KOLASCH & BIRCH, PO BOX 747, FALLS CHURCH, VA, 22040-0747, US

(73) Assignee: A4SP Technologies Oy, Espoo (FI)

(21) Appl. No.: 12/740,963

(22) PCT Filed: Oct. 31, 2008
(86) PCT No.: PCT/FI08/50624

§ 371 Date: Jun. 4, 2010

(30) Foreign Application Priority Data
Oct. 31, 2007 (FI) 20075775

(51) Int. Cl. G06F 19/00

(52) U.S. Cl. 700/91

(57) ABSTRACT

A system for a sports activity, which system is adapted to detect potential game contacts that include contacts between games equipment (1) and a games object (2) and/or contacts between a games object (2) and a target surface (5), and the system comprises sensor means (3a, 3b) adapted to detect vibrations caused by potential game contacts and to convert these vibrations into sensor signals. The system is adapted to
define the value of the sensor signal at several consecutive discrete time instants,
define for a sensor signal section within a time frame k that contains N sensor signal values an energy value quantity E[k] that is related to the energy of the sensor signal section,
repeat the above step of defining the energy value quantity of the sensor signal section for several consecutive time frames, and
detect a potential game contact by utilizing a detection function D that is obtained by a linear combination of energy value quantities of sensor signal sections contained in consecutive time frames by using the formula

$$D [ k ] = {\sum }_{i = 0}^{K - 1} {c}_{i} E [ k - i ] ,$$

wherein K is the number of energy value quantities used in calculation and an integer equal to or greater than two, and cᵢ is a weighting coefficient for the energy value quantity E[k−i], whereby the detection of a potential game contact in the time frame k is based on comparing the value D[k] of the detection function D corresponding to the time frame k is compared with a threshold value.

### BACKGROUND OF THE INVENTION

The invention relates to a system for a sports activity.

When training for a sports activity and/or during a sports activity, it is often beneficial to be able to automatically register game contacts, that is, contacts between games equipment and a games object and/or between a games object and a target surface. Herein, games equipment refers to a playing means, such as floorball stick, tennis racket, baseball bat, or ice-hockey stick, or some other means adapted to move the games object, such as a ball or puck. Depending on the sport, the games equipment may be a shoe, such as in the case of football. The target surface may be a wall against which an athlete training floorball hits the ball with his or her stick.

The detection of game contacts may be based on the use of acceleration and/or sound sensors. Several types of these sensors are known, and they are universally available.

WO publication 2005/077115 discloses an impact-sensing system for automatically detecting for example a boxer's hits at the punching bag by means of acceleration sensors. An impact is detected when the output signal of the acceleration sensor located in a punching bag exceeds a predefined limit value.

In most sports, detecting the game contact merely on the basis of an acceleration or sound sensor output value exceeding a limit value is not sufficiently reliable. In floorball, for instance, the stick of the player may hit the floor or another stick and produce false game contact detection.

### BRIEF DESCRIPTION OF THE INVENTION

It is thus an object of the invention to develop a system for a sports activity, which is reliably able to detect game contacts. The object of the invention is achieved by a system that is characterised by what is stated in the independent claim. Preferred embodiments of the invention are disclosed in the dependent claims.

The invention is based on the idea that the system is adapted to detect a potential game contact by using a special detection function whose initial information relate to energy value quantities of several different time frames of a sensor signal received from sensor means.

In an embodiment of the invention, the system is also adapted to classify detected potential game contacts by using at least one classification algorithm that is adapted to determine whether a potential game contact is a true game contact or a false detection.

The system of the invention provides the advantage that a game contact can be detected more reliably than before.

### BRIEF DESCRIPTION OF FIGURES

The invention will now be described in greater detail by means of preferred embodiments and with reference to the attached drawings, in which

FIG. 1 shows a system for a sports activity according to an embodiment of the invention;

FIG. 2 shows the working principle of the system of FIG. 1 by means of a process chart; and

FIGS. 3A to 3C are graphical representations of detecting potential game contacts on the basis of a sensor signal by utilising an embodiment of the invention.

### DETAILED DESCRIPTION OF THE INVENTION

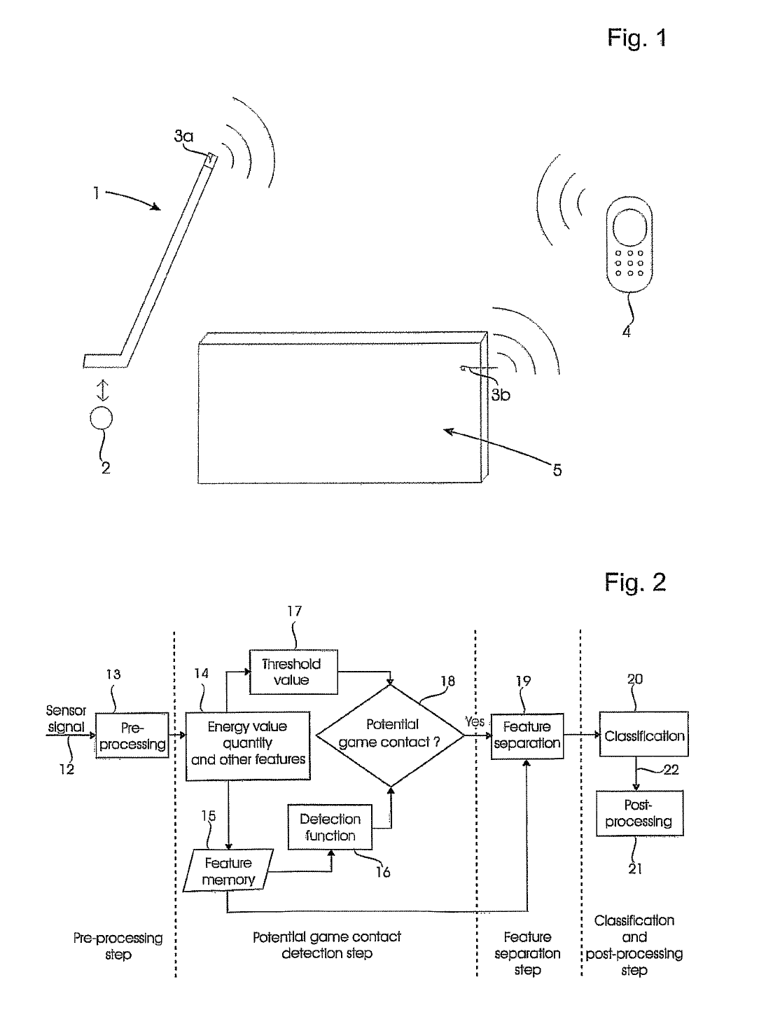

The system for a sports activity according to FIG. 1 comprises games equipment 1, a games object 2, sensor means 3a, 3b, and a host device 4. The games equipment 1 is a floorball stick, the games object 2 is a floorball ball, the host device 4 is a mobile phone, and the sensor means comprise a games equipment sensor 3a and target surface sensor 3b.

The games equipment sensor 3a is connected to the games equipment 1 and adapted to detect vibrations caused to the games equipment 1 by the contact between the games equipment 1 and games object 2. The target surface sensor 3b is connected to the target surface 5 and adapted to detect vibrations caused to the target surface 5 by the contact between the games object 2 and target surface 5. The target surface 5 may be a separate wall element or part of a sports hall wall, for example.

The sensor means are arranged to detect vibrations caused by potential game contacts, to convert these vibrations to sensor signals, and to determine the value of the sensor signal at several consecutive time instants. The sensor means may comprise a known acceleration or sound sensor. The sensor means may thus comprise a piezoelectric sensor, for instance.

FIG. 2 shows the working principle of the system of FIG. 1 by means of a process chart. The sensor signal is pre-processed in step 13, a potential game contact is detected by means of steps 14 to 18, feature separation is performed in step 19, and the classification and post-processing of potential game contacts are performed in steps 20 to 22.

The sensor means convert the detected vibrations into signals 12 that are further sampled and quantized with an A/D converter into discrete-time signals. The signal 12 may be pre-processed in step 13 by down-sampling or digital filtering. In step 14 an energy value quantity is calculated for the signal and the possibly band-pass filtered sub-bands of the signal in several consecutive time frames, each of which contains several discrete-time sensor signal values. The energy value quantities are associated with the energy of corresponding sensor signal sections, and the energy value quantities are used in step 16 as input values of the detection function and in certain embodiments in calculating values of a threshold value function in step 17, and as features when classifying game contacts in step 20. In step 14, other features than just the energy value quantities may also be defined for the sensor signal. The energy value quantities and other features defined for the time frames are stored into a feature memory in step 15. The detection of a potential game contact takes place in step 18, in which each detected potential game contact is also provided with a time stamp related to the time of incident of the potential game contact. The time stamps of potential game contacts classified as actual game contacts in step 20 are transmitted in step 22 for post-processing and analysis that take place in step 21.

The time frames may partially overlap in such a manner that one or more of the several discrete-time sensor signal values in a given time frame k and the one k−1 preceding it are common to the time frames k and k−1. The partial overlap of the time frames reduces the steepness of the detection function reaction and, thus, improves the reliability of the detection of potential game contacts in certain embodiments. The overlap of the frames also improves the time resolution of feature separation, if standard-length time frames are used.

The energy value quantity defined for a sensor signal section in a time frame may be a quantity representing the root mean square (RMS) value, for instance, that may be calculated for a time frame ending at a time instant n for example from the formula

$${E}_{RMS} [ n ] = \sqrt{\frac{1}{N} {\sum }_{j = 0}^{N - 1} {x}^{2} [ n - j ]} ,$$

where N is the length of the time frame being examined and x is the sensor signal value at a discrete time instant.

The system may be adapted to use standard-length time frames. In an alternative embodiment, the system may be adapted to vary the length of the time frames as necessary.

The system of the invention is adapted to detect a potential game contact by utilising a detection function D that is obtained as a linear combination of the energy value quantities of sensor signal sections in consecutive time frames by using the formula

$$D [ k ] = {\sum }_{i = 0}^{K - 1} {c}_{i} E [ k - i ] ,$$

where K is the number of energy value quantities used in the calculation, k is the frame index, and cᵢ is a weighting coefficient for the energy value quantity E[k−i], whereby the detection of a potential game contact is based on comparing the value D[k] of the detection function D corresponding to the time frame k is compared with a threshold value.

The values of the coefficients K and cᵢ of the detection function depend on the embodiments. The coefficient K is an integer that is equal to or greater than two, but finite. The values of coefficients cᵢ are real numbers. In an embodiment, the detection function is calculated using the values K=3, c₀=2, c₁=c₂=−1, whereby the detection function Dₑ obtains the form

Dₑ[k]=2E[k]−E[k−1]−E[k−2].

In an alternative embodiment, K=3, c₀=1, c₁=0 and c₂=−1. In another alternative embodiment, K=2, c₀=1 and c₁=−1. In yet another alternative embodiment, K=2, c₀=0.5 and c₁=−0.5.

The system of FIG. 1 is adapted to detect potential game contacts between the games equipment 1 and games object 2 on the basis of the output signal of the games equipment sensor 3a. The system can be adapted to detect a potential game contact on the basis of a sensor signal of the games equipment sensor 3a in a situation in which the detection function D obtains a higher value than an adaptive threshold value function A in the examined time frame, that is, when

D[k]>A[k].

The adaptive threshold value function A may be defined as follows:

$$A [ k ] = \{ \begin{matrix}{A}^{′} [ k ] , when & {A}^{′} [ k ] > {d}_{0} \\ {d}_{0} , when & {A}^{′} [ k ] \leq {d}_{0}\end{matrix}$$

wherein k is the index of the examined time frame, d₀ is a basic value of the threshold, and

$${A}^{′} [ k ] = \frac{b}{M} {\sum }_{m = 0}^{M - 1} \vert {D}^{′} [ k - m ] \vert ,$$

wherein M is the number of values used in calculating a moving average, b is a scaling coefficient, and D′ is the detection function D calculated using certain values K and cᵢ. M is greater than or equal to 1, and b is a real number that is equal to or greater than zero. The value of M affects how steeply or gently the threshold value function reacts to energy changes, and b ensures suitable scaling of the threshold value function in relation to the function D. Both M and b may be constants. Alternatively, M or b or both may be time-dependent.

In an embodiment, in which the amplitude of the sensor signal is −1 . . . 1 and sampling frequency is 8820 Hz, the following values are used in the calculation: N=176, K=3, c₀=2, c₁=−1, c₂=−1, b=8, M=20 and d₀=0.03. In this embodiment, the length of the frame is 20 ms, and consecutive time frames have 132 common samples, whereby the partial overlap of the time frames is 15 ms, that is, 75%.

The value and development of the adaptive threshold value function may be used as features of a potential game contact, and they may be used to assist in classifying the potential game contact in step 20.

The adaptive threshold value has two main tasks. Firstly, it adapts the detection level to the energy level of the sensor signal, and secondly, it drowns error detections, such as double contacts after the actual game contact. The latter is possible because the delay caused by the formula A′[k] is not compensated.

To avoid faulty detection incidents, the system may be adapted to use a double detection time constant τ in such a manner that during a period of the length of the double detection time constant τ after the detection of a potential game contact, the system does not detect potential game contacts, even though the criteria meeting their detection were fulfilled.

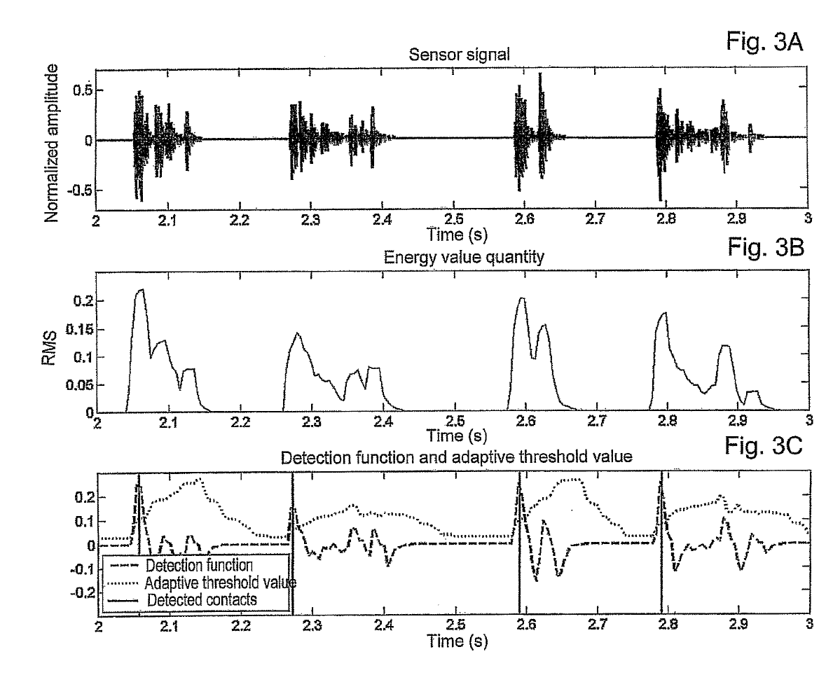

FIG. 3A shows a sensor signal obtained from the games equipment sensor as a function of time, while the amplitude is normalized. FIG. 3B shows the curve of the RMS value calculated for the sensor signal. FIG. 3C shows the curve of the detection function D defined on the basis of the RMS values and the curve of the adaptive threshold value function A. The potential game contacts detected by the system are marked with vertical lines in FIG. 3C.

FIG. 3C shows clearly that without the adaptivity of the threshold value function, that is, if the threshold value were continuously equal to the basic value d₀, the system would have erroneously detected several extra potential game contacts. FIG. 3C also shows that the threshold value could not be given so high a constant value that all faulty detections remained below it. This is simply due to the fact that the detection function D obtains a higher value at some points, where a game contact does not in reality take place, than at some actual game contacts.

The detected potential game contacts are classified as actual game contacts and false detections at step 20 of the process chart of FIG. 2. In the case of the system of FIG. 1, the classification of the potential game contacts may be done either in a sensor unit, which may be a games equipment sensor 3a or target surface sensor 3b, or in the host device 4. If the classification is done in the sensor unit, of the data processed by the algorithm only the time information of incidences classified as actual game contacts are transmitted over wireless data transmission connection to the host device. If the classification is done in the host device 4, not only the time stamp is transmitted, but also the features separated from the signal in step 14 and stored in the feature memory in step 15.

The classification of potential game contacts may be done using many different methods, among other things by using a binary decision tree based on an analysis of signal features stored using the system. By examining features related to actual game contacts, it is possible to derive a group of decision rules that may be applied at the nodes of the tree. In combination with causal relationships of rules typical of the classes, it is possible to form a decision tree whose leaves correspond to predefined classes. It is also possible to apply to the classification a learning method or some other classification method. Classifiers suitable for this algorithm are, for instance, a decision tree that learns from data, a neural network, or Bayesian pattern recognition systems, such as Bayes networks.

The classification of potential game contacts defines which time stamps are used in the post-processing of step 21 which may be done in the host device 4. On the basis of time information, the game contacts may be statistically analyzed or otherwise post-processed as necessary.

When a potential game contact has been detected in step 18, an action is performed to it which is herein called feature separation. Feature separation is done in step 19 by utilizing the features that are stored in the feature memory in step 15.

Feature separation is done by detaching computationally from the signal certain features in connection with the detection of a game contact, after which at least one suitable classification algorithm is applied to the features. The features of actual game contacts are different from those of error detections, so by examining the features, the classification algorithm can decide whether the potential game contact is an actual game contact or error detection.

In the system of the invention, the feature separation and classification may be done as follows:

1. At the time of detection k₀, the memory of the system contains not only an energy value quantity E[k₀], but also previous values of E that have been used to define D[k₀].

2. At the time of detection k₀, the memory also contains other features calculated from a sensor signal, for instance values of E[k₀] calculated on certain pass-bands.

3. The values that were in the memory at the time of detection k₀, are kept in the memory, and corresponding features for the following h time frames are also stored into the memory.

4. The features in the memory or a subset of them are used as input for the classification algorithm that decides on the nature of a potential game contact.

In some cases, it is possible that after a first potential game contact, which is an error detection, another potential game contact, which is an actual game contact, occurs within a short time. In such a case, the adaptive threshold value that increases after the first potential game contact may drown the detection function value of the actual game contact, whereby the actual contact would remain undetected. In these cases, it is possible to apply an alternative threshold value calculation that works in such a manner, for instance, that after a detected potential game contact, a conditional threshold value function obtains linearly increasing values for a predefined time starting from the detected potential contact as a function of the measured time. The value of the detection function is compared with the value of this conditional threshold value function, if and only if the feature separation process for the first detected potential game contact is finished and the first detected potential game contact is classified as an error detection. If this happens, a new time stamp is stored into the memory and a new feature separation process for the incident detected on the basis of the conditional threshold value comparison may be started.

In embodiments where one sensor may detect many actual game contacts of different types, it is possible during the classification step to not only distinguish the actual game contacts from error detections but also to classify the actual game contacts. In addition to time stamps, information on the classification of game contacts may also be used in post-processing in step 21.

The system of the invention may be adapted to determine the velocity of a games object. The velocity of a games object may be calculated by means of the difference between the time stamp of the game contact detected by the games equipment sensor and the time stamp of the game contact detected by the target surface sensor, when the distance from which the athlete sends the games object in movement towards the target surface is known. The game contact detected by the games equipment sensor is a contact between the games equipment and games object, for instance the contact between a floorball stick and ball when the athlete hits the ball with the stick, and the game contact detected by the target surface sensor is the contact between the games object and target surface, for instance the contact between a floorball ball and sports hall wall. The velocity is obtained in a known manner as a quotient of the distance travelled by the games object and the time it takes to travel that distance.

When the system of the invention is used to determine the velocity of the games object, for detecting the game contact between the games equipment and games object on the basis of the sensor signal of the games equipment sensor, it is possible to use the detection function −D[k], wherein D[k] is the detection function described above. The used detection function Dᵥ[k] is thus

$${D}_{v} [ k ] = - {\sum }_{i = 0}^{K - 1} {c}_{i} E [ k - i ] ,$$

whereby the detection of the games equipment contact is based on the attenuation of the energy value quantity of the sensor signal. With this method the time of incident, that is, time stamp of the game contact between the games equipment and games object is determined more accurately than by monitoring the increase in the energy value quantity of a sensor signal. However, for detecting the game contact between the games object and target surface on the basis of the sensor signal of the target surface sensor, it is possible to use the detection function D[k], whereby the detection of the games equipment contact is based on the increase in the energy value quantity of a sensor signal. When analyzing the sensor signals of both the games equipment sensor and target surface sensor, the used threshold value may be a predefined fixed threshold value.

The above data on the application of the system of the invention to the determination of the velocity of the games object are based on studying a floorball embodiment. In the study, the games equipment sensor was fastened to a floorball stick that was used to hit floorball balls toward a wall equipped with a target surface sensor. However, there is reason to assume that the above data may also be utilized in determining the velocity of a games object in other sports activities.

Either a mean velocity or initial velocity may be defined for a games object. The initial velocity of a games object may be defined on the basis of compensated time stamps and the aerodynamic and mechanical properties of the moving games object.

It is obvious to a person skilled in the art that the basic idea of the invention may be implemented in many different ways. Thus, the invention and its embodiments are not limited to the above examples, but may vary within the scope of the claims.

1. A system for a sports activity, which system is adapted to detect potential game contacts that include contacts between games equipment and a games object and/or contacts between a games object and a target surface, and the system comprises sensor means adapted to detect vibrations caused by potential game contacts and to convert these vibrations into sensor signals, wherein the system is adapted to
define the value of the sensor signal at several consecutive discrete time instants,
define for a sensor signal section within a time frame k that contains N sensor signal values an energy value quantity E[k] that is related to the energy of the sensor signal section,
repeat the above step of defining the energy value quantity of the sensor signal section for several consecutive time frames, and
detect a potential game contact by utilizing a detection function D that is obtained by a linear combination of the energy value quantities of the sensor signal sections contained in the consecutive time frames by using the formula
$$D [ k ] = {\sum }_{i = 0}^{K - 1} {c}_{i} E [ k - i ] ,$$
wherein K is the number of energy value quantities used in calculation and an integer equal to or greater than two, and cᵢ is a weighting coefficient for the energy value quantity E[k−i], whereby the detection of a potential game contact in the time frame k is based on comparing the value D[k] of the detection function D corresponding to the time frame k with a threshold value.

2. A system as claimed in claim 1, wherein the consecutive time frames may partially overlap.

3. A system as claimed in claim 1, wherein potential game contacts, the vibrations caused by which the sensor means are adapted to detect, comprise a contact between games equipment and a games object, and the system detects a potential game contact if the detection function D obtains in the examined time frame a higher value than an adaptive threshold value function A, that is, when
D[k]>A[k].

4. A system as claimed in claim 3, wherein the adaptive threshold value function A is defined as follows:
$$A [ k ] = \{ \begin{matrix}{A}^{′} [ k ] , when & {A}^{′} [ k ] > {d}_{0} \\ {d}_{0} , when & {A}^{′} [ k ] \leq {d}_{0}\end{matrix}$$
wherein k is a discrete time index, d₀ is a base value of the threshold value, and
$${A}^{′} [ k ] = \frac{b}{M} {\sum }_{m = 0}^{M - 1} \vert {D}^{′} [ k - m ] \vert ,$$
wherein M is the number of values used in calculating a moving average, b is a scaling coefficient, and D′ is the detection function D calculated with given values K and cᵢ.

5. A system as claimed in claim 3, wherein the sensor means comprise a games equipment sensor that is adapted to be fastened to the games equipment and to detect vibrations caused in the games equipment by a contact between the games equipment and games object.

6. A system as claimed in claim 1, wherein potential game contacts, the vibrations caused by which the sensor means are adapted to detect, comprise a contact between the games object and target surface, and the sensor means comprise a target surface sensor that is adapted to be connected to the target surface and to detect vibrations caused in the target surface by a contact between the games object and target surface.

7. A system as claimed in claim 1, wherein the energy value quantities of the sensor signal sections are effective values, whereby the energy value quantity for a time frame ending at time instant n is obtained from the formula
$${E}_{RMS} [ n ] = \sqrt{\frac{1}{N} {\sum }_{j = 0}^{N - 1} {x}^{2} [ n - j ]}$$
wherein N is the length of the examined time frame, and x is the value of the sensor signal at a discrete time instant.

8. A system as claimed in claim 1, wherein to avoid error detections, the system is adapted to use a double detection time constant in such a manner that during a period of the length of the double detection time constant after a potential game contact, the system does not detect potential game contacts, even though their criteria for detection were met.

9. A system as claimed in claim 1, wherein in that the system is also adapted to classify detected potential game contacts by using at least one classification algorithm that is adapted to determine whether a potential game contact is an actual game contact or error detection.

10. A system as claimed in claim 1, wherein the system is also adapted to provide each detected potential game contact a time stamp that is associated with the time when the potential game contact took place.
